(19) United States
(12) Patent Application Publication
(10) Pub. No.: US 2016/0296419 A1
(43) Pub. Date: Oct. 13, 2016

(54) MOVING BOX AUTOMATED CARDIO PULMONARY RESUSCITATION DEVICE

(71) Applicant: KONINKLIJKE PHILIPS N.V.

(72) Inventors: IGOR WILHELMUS FRANCISCUS PAULUSSEN, NEUNEN (NL); WILLEM-JAN VAN ROOIJ, NEUNEN (NL); PIERRE HERMANUS WOERLEE, VALKENSWAARD (NL); GERRIT JAN NOORDERGRAAF, DIESSEN (NL)

(73) Assignee: Koninklijke Philips N.V.

(21) Appl. No.: 15/100,847

(22) PCT Filed: Nov. 28, 2014
(86) PCT No.: PCT/EP2014/075880

§ 371 Date: Jun. 1, 2016

(30) Foreign Application Priority Data
Dec. 3, 2013 (EP) 13195433.1

(51) Int. Cl. A61H 31/00

(52) U.S. Cl. CPC A61H 31/006; A61H 2201/5061; A61H 2201/1207

(57) ABSTRACT

A Cardiac Pulmonary Resuscitation (CPR) device (CPD) for performing CPR on a patient (PT). A supporting structure (L1, L2, F) with two legs (L1, L2) shaped to accommodate space for the patient's (PT) thorax between them. The legs (L1, L2) have clamp mechanisms (CL1, CL2) to allow clamping onto a backboard (BB). A compression box (CB) with a plunger mechanism (PM) with a contact pad (CP) projecting downwards from the enclosure (CS), and a processor (P) for controlling the plunger mechanism (PM) to perform CPR on the patient (PT) in an automatic manner. A height adjustment mechanism (H) is used to fix a height (h) of the compression box (CB) relative to the supporting structure (L1, L2, F). The height adjustment mechanism (H) can allow the compression box (CB) to move in relation to the supporting structure (L1, L2, F) in a first operating state, by help of gravity. Hereby, the compression box (CB) can enter a height (H) where the contact pad is in contact with the patient's (PT) chest, preferably within a predetermined contact force range, upon clamping of the supporting structure (L1, L2, F) onto the backboard (BB). Hereby, the height and contact force parameters are inherently set automatically by the device, when the operator has clamped the CPR device (CPD) onto the backboard (BB). This setup task is easy for the operator, time without CPR can be saved, and CPR can be initiated with a correct contact force.

### FIELD OF THE INVENTION

The present invention relates to the field of medical devices, more specifically to the field of automated cardio pulmonary resuscitation (ACPR) devices.

### BACKGROUND OF THE INVENTION

Manual Cardio Pulmonary Resuscitation (CPR) is difficult to perform in a consistent high-quality manner. However, consistent high quality chest compressions, is key for survival, and thus there is a strong drive to have a mechanical automated CPR device (A-CPR) to replace less reliable, frequently interrupted, difficult to control, and sometimes lengthy in duration manual CPR. Examples of A-CPR devices are disclosed in US 2012/0238922 A1 and EP 1 913 924 A1, wherein US 2012/0238922 A1 discloses an A-CPR device that includes a plunger driven by a drive to perform a compressive massage on a patient's body, a position measuring device that measures the respective position of the plunger during its compressive massaging motion, and a holding device for the drive and the plunger. EP 1 913 924 A1 discloses a support for an A-CPR device comprising a back plate, a front part, and a side part, wherein the front part comprises a seat for a compression member and that the side part is adapted to provide adjustable spacing between the seat and the back plate.

A number of A-CPR devices exist, and the market is rapidly growing as caregivers come to realize their essence. Typically, such devices are mounted on a backboard on which the patient rests. However, important issues with current A-CPR devices include long set-up times, low stability during operation of the device, as well as suggestions and clinical evidence that insufficient force is being applied for optimal performance.

To adjust the height during initial setup, the operator needs to adjust height of the legs of the device, or to adjust a position of adjusting the length of the plunger mechanism. However, such setup requires time before CPR can be activated, and often results in a not optimal starting height, therefore resulting in a not optimal force on the patient's chest, and hence a not optimal CPR treatment, once the CPR is activated.

### SUMMARY OF THE INVENTION

It would be advantageous to provide an A-CPR device and a method for using such device which allows a fast setup time, and at the same time ensures that a sufficient contact force is applied during the automatic CPR procedure.

In a first aspect, the invention provides a CPR device arranged to perform CPR on a patient, the CPR device comprising: the device comprising:

a supporting structure comprising first and second legs shaped to accommodate space for the patient's thorax between the first and second legs, wherein the first and second legs each has a clamp mechanism arranged for engagement with corresponding clamp mechanisms on each side of an associated backboard, so as to allow an operator to clamp the supporting structure onto the associated backboard,

a compression box comprising an enclosure containing:
a plunger mechanism with a contact pad projecting downwards from the enclosure, and arranged to provide a chest compression force to the patient's chest, and
a processor arranged to control the plunger mechanism to perform Cardiac Pulmonary Resuscitation on the patient, and
   the device further comprising:

a height adjustment mechanism arranged to fix a height of the compression box relative to the supporting structure, wherein in a first operating state of the device, upon clamping of the supporting structure onto the associated backboard, the height adjustment mechanism is arranged to allow the compression box to slide by gravity in relation to the supporting structure, so as to press the contact pad against the patient's chest with a force determined by the mass of the compression box, and

a spring mechanism arranged to force the compression box downwards, so as to press the contact pad against the patient's chest with a predetermined force.

Such CPR device is advantageous for an easy and fast initial setup, thus enabling a quick initiation of automated CPR treatment of a patient. At the same time, a sufficient force on the patient's chest is also ensured by the CPR device. This is obtained, since, in the first operating state, i.e. an initial state of the CPR during setup, the compression box is allowed to move. Hereby, the contact pad is allowed to be in contact with the patient's chest, while an operator clamps the supporting structure onto the associated backboard. Thus, after the operator has clamped the CPR device onto the associated backboard, a suitable height of the compression box is automatically obtained without the need for any further adjustment by the operator, or by the device itself. An advantage is that it is possible to use a plunger mechanism, where the plunger has a fixed position relative to the compression box, in contrast to prior art device with moving plunger principles, e.g. a telescopic type plunger that can be retracted relative to the compression box.

The height can then be manually or automatically fixed by means of the height adjustment mechanism, whereafter a CPR sequence can immediately be activated. Hereby, time is saved, and still the weight of the compression box can be matched to provide a suitable force of the contact pad against the patient's chest by gravity acting on the compression box. If the patient's chest sink during CPR, a force sensor in the device may be able to detect that insufficient force is applied, and in response, the height adjustment mechanism can be automatically released, and the compression box will then be allowed to move downwards by gravity, and again to press against the patient's chest by a suitable force. After this, the height adjustment mechanism can again be used to fix the height of the compression box, and a CPR sequence can be re-activated.

The compression box preferably comprises all necessary electronics and drive train to be able to perform a CPR sequence on a patient. The CPR device is arranged for the initial setup of an operator when it is in the first operating state, e.g. an “off” state or “stand-by” state, i.e. where the operator is expected to clamp the supporting structure onto an associated backboard, where the patient rests. Thus, the first and second legs are placed on each side of the patient's thorax. Activation of a CPR sequence is initiated after the height adjustment mechanism has fixed the height of the compression box. This height fixation can be initiated automatically, e.g. in response to sensors in the clamps of the first and second legs arranged to detect when the supporting structure has been correctly clamped onto the associated backboard. When this is detected, the height can be fixed, e.g. automatically by means of an electrical locking mechanism, e.g. by an electrically actuated pin-in-hole arrangement. The height could also be fixed by the operator by means of a tightening handle, or another locking mechanism. After the height has been fixed, the processor can be arranged to automatically activate a CPR sequence, i.e. an “on” state of the device.

Thus, the CPR device is easy to operate, since the operator can be relieved from the difficult and time consuming task of initially adjusting the height of the contact pad. Especially, the inexperienced operator may spend a significant amount of time on such task, and still arrive at a contact pad height which does not provide sufficient force onto the patient's chest during the CPR. Further, in fully automated versions of the CPR device, i.e. where the CPR sequence is automatically started after the device has detected correct clamping of the supporting structure onto the associated backboard, the initial setup procedure can be completed in a very short time, even by an inexperienced operator, and thus important non-CPR time can be saved.

Still further, the CPR device is advantageous, since it can be produced in version where the supporting structure is one rigid structure with fixed legs, because the compression box is the one that provides the height adjustment. Thus, the overall height of the device during storage can be limited, since the compression box will can then be in its lower position. Yet further, with the possibility of a CPR device with a fixed (rigid) supporting structure, the CPR device may be even easier to setup, since the legs can be shaped to precisely fit to the backboard clamps, without requiring any initial adjustment or unfolding of the legs. Even further, the moving compression box allows the legs to be shaped, e.g. curved, to accommodate good space for the patient's thorax, and still the compression box can be made compact to provide good visibility of the patient's thorax for the operator during setup. E.g. a width of the compression box is smaller than a distance between the clamps on the sides of associated backboard, e.g. smaller than 80% of said width, such as smaller than 60% of said width, such as smaller than 40% of said width, thus providing a good visibility for the operator. In other embodiments, the first and second legs may be straight, or substantially straight.

The height adjustment mechanism is arranged to allow the compression box to slide by gravity, so as to press the contact pad against the patient's chest with a force determined by the mass of the compression box, in the first operating state. Additionally, a spring mechanism is arranged to force the compression box downwards, so as to press the contact pad against the patient's chest with a predetermined force, in the first operating state. Thus, the compression box may be suspended such that it can freely move by gravity, and thus by selecting the mass of the compression box within a suitable range, it is possible to control the initial force of the contact pad against the patient's chest. This gravity principle is combined with an additional spring mechanism to either reduce or increase the force which the contact pad presses against the patient's chest, in the first operating state. This allows e.g. a reduction of the mass of the compression box, and still a spring mechanism can increase the pressing force to a desired value, and thereby enabling a CPR device which is easy to handle for the operator, and still provides the above-mentioned advantages of providing enough initial pressing force. Alternatively, means for providing friction force and/or a spring force may be used to reduce the resulting force of the compression box, in case the free weight of the compression box will provide a too large contact force.

The height adjustment mechanism may be arranged to fix a height of the compression box relative to the supporting structure, in a second operating state. Especially, the processor may be arranged to enter the second operating state in response to one of: an input from the operator, and an input from a sensor informing the processor that the supporting structure has been clamped onto the associated backboard. Thus, the second operating state, e.g. an “on” state, may be initiated manually by the operator when he/she has finished clamping the supporting structure onto the associated backboard, or it may be initiated automatically by the CPR device itself.

The processor may be arranged to initiate a CPR sequence, after the height adjustment mechanism has fixed the height of the compression box relative to the supporting structure. Such start of the CPR treatment may be initiated automatically by the processor, e.g. after it has detected that the height mechanism has fixed, e.g. locked, the height of the compression box. In case the height adjustment mechanism is to be operated by the operator, e.g. by tightening a knob, inserting a pint or the like, the CPR sequence may be initiated either automatically by the processor, or by the operator activating the CPR sequence by pressing a “start” button. Since there is no need for a manual height adjustment, after the CPR device has been clamped onto the associated backboard, valuable time may be saved by an automated detection of correct clamping onto the backboard, an automated initiation of fixation of the height, and finally an automated initiation of a CPR sequence. Hereby, the operator is relieved from potentially stressful operations, and unnecessary delays of the CPR sequence start can be eliminated.

Preferably, the height adjustment mechanism may be arranged to fix a height of the compression box relative to the supporting structure in one of a plurality of possible height positions, e.g. a limited number of fixed positions between an upper position and a lower position, e.g. by means of holes in the compression box structure or a structure rigidly connected to the compression box, and an electrically operated pin-arrangement fastened to the supporting structure, serving to engage with one of said holes, so as to fix a height position of the compression box, and thus provide a rigid connection between the compression box, and the associated backboard, when the supporting structure has been clamped onto the backboard. Other methods including applying friction, rack and pinions etc. may be used additionally or alternatively.

The height adjustment mechanism may be arranged to fix a height of the compression box relative to the supporting structure in a position corresponding to an actual height position of the compression box, upon activation of the CPR device. This is advantageous, since during the initial clamping onto the associated backboard, the compression box will automatically be in the correct height position, and thus can be fixed in this position as soon as the manual clamping procedure has been performed. As already mentioned, the activation of the CPR device may be in response to a manual activation by the operator, or the processor may activate the CPR device in response to detection that a correct clamping onto the associated backboard has been obtained.

The height adjustment mechanism may comprise a locking pin arrangement arranged to fix a height of the compression box relative to the supporting structure, in one of a limited number of height positions. Such locking pin arrangement can be formed in different ways, and be automatically controlled by the processor in response to various inputs, or it can be manually operated by the operator.

The height adjustment mechanism may be arranged to fix a height of the compression box relative to the supporting structure, in response to an output from the processor. Hereby, enabling an automatic fixation of the height e.g. in response to the processor receiving an input from a sensor, e.g. a sensor integrated in one or both clamping mechanisms of the first and second legs arranged to sense that correct clamping has been achieved. This may help to eliminate time required for the operator to take the decision and perform a manual activation of the CPR device after the initial clamping of the supporting structure onto the associated backboard. However, it is to be understood that it may be implemented that the contact force may be controlled or adjusted after the height adjustment procedure has been performed.

The height adjustment mechanism may be arranged to release the compression box from a fixed height position relative to the supporting structure, in response to an output from the processor. Hereby, a self-adjustment height mechanism can be obtained without the need for a motorized height adjustment, since the release of the compression box will allow the compression box to fall down, e.g. by gravity, to press the contact pad against the patient's chest with a predetermined force. It is to be understood that this movement of the compression box may be controlled by introducing friction and/or a spring effect or other opposing force, in case it is considered that a free falling compression box will provide a too violent fall of the compression box, and thus a too large force on the patient's chest. Hereby, the CPR device can adapt to the patient's chest sinking during a CPR sequence, and thus the CPR device can automatically adapt to this by lowering the compression box, and re-activating CPR quickly after the height adjustment mechanism has fixed the compression box in the new, lower position. Especially, the processor may generate said output causing the release of the compression box in response to a detected force applied to the patient's chest being below a predetermined threshold value. Thus, during CPR, the CPR device may monitor the applied force by means of a force sensor, and if the detected force falls below a predetermined threshold value, CPR can be aborted, and the processor can control the height adjustment mechanism to release the compression box, which can then fall to a lower height and thus press against the patient's chest in the same way as during initial setup.

The supporting structure may comprise a frame structure rigidly connected to the first and second legs, so as to form a rigid supporting structure, and wherein the compression box is arranged to slide inside the frame. Alternatively, the height adjustment mechanism may be positioned at least partly inside structures forming the first and second legs.

In a second aspect, the invention provides a method for initial setup of a device for performing CPR on a patient. The CPR device comprises a supporting structure comprising first and second legs shaped to accommodate space for the patient's thorax between the first and second legs, a compression box comprising an enclosure containing a plunger mechanism with a contact pad projecting downwards from the enclosure, and arranged to provide a chest compression force to the patient's chest, and a processor arranged to control the plunger mechanism to perform Cardiac Pulmonary Resuscitation on the patient, a height adjustment mechanism, and a spring mechanism, the method comprising

entering a first operating state of the device, wherein the height adjustment mechanism is arranged to allow the compression box to slide by gravity in relation to the supporting structure with a force determined by the mass of the compression box, and the spring mechanism is arranged to force the compression box downwards so as to press the contact pad against the patient's chest with a predetermined force,

manually clamping the supporting structure onto an associated backboard, and

fixing a height of the compression box by means of the height adjustment mechanism and the spring mechanism after the supporting structure has been clamped onto the associated backboard.

As already explained, this method allows elimination of a manual height adjustment step, thus allowing initial setup to be speeded up, and thus reducing non-active CPR time. The manual step of clamping the supporting structure onto the associated backboard is the only manual task for the operator to perform, which can be made an easy task with a rigid supporting structure with fixed legs that fit to the size of the associated backboard and which may be fitted with clamps that allow the operator to have an audible click as feedback of the CPR device being correctly clamped onto the associated backboard. The CPR device may then automatically fix the height and initiate a CPR sequence without any further involvement of the operator.

It is appreciated that the same advantages and embodiments of the first aspect apply as well for the second aspect. In general the first and second aspects may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a sketch of an embodiment seen from above,

FIG. 2 illustrates side view sketches of an embodiment with the compression box in lower and upper position,

FIG. 3 illustrates side view sketches of another embodiment with the compression box in lower and upper position,

FIG. 4 illustrates two steps of a method for mounting a CPR device onto a backboard with a patient lying thereon,

FIG. 5 illustrates two steps of another method for mounting a CPR device onto a backboard with a patient lying thereon,

FIG. 6 illustrates a block diagram of an example of elements contained in a compression box of a CPR device embodiment, and

FIG. 7 illustrates a diagram of steps of a method embodiment.

### DESCRIPTION OF EMBODIMENTS

FIG. 1 illustrates a CPR device embodiment seen from above. The CPR device comprises a supporting structure with two legs L1, L2 shaped to accommodate space for the patient's thorax between the two legs L1, L2. The two legs L1, L2 are rigidly connected to a frame F. The two legs L1, L2 each has a clamp mechanism CL1, CL2 arranged for engagement with corresponding clamp mechanisms on each side of an associated backboard. Hereby, an operator can clamp the supporting structure onto a backboard, such that the supporting structure is locked in position onto the backboard. Preferably, the legs L1, L2 and the frame F are rigidly connected and shaped such that the clamp mechanisms CL1, CL2 fit onto the clamp mechanisms on the backboard. Hereby, the operator can easily position the CPR device and clamp it onto the backboard.

A compression box CB is arranged within the frame F, and the compression box CB comprises an enclosure containing a plunger mechanism, and a processor arranged to control the plunger mechanism. A contact pad projects downwards from the enclosure, and the contact pad is arranged to provide a chest compression force to the patient's chest by moving up and down, and thus perform CPR on a patient. The plunger mechanism is preferably fixed in relation to the enclosure of the compression box.

The compression box CB is mounted to a height adjustment mechanism H which is arranged to fix a height of the compression box CB relative to the supporting structure L1, L2, F. To perform CPR, the compression box CB needs to be fixed to the supporting structure L1, L2, F so as to be able to provide the necessary plunging forces onto the patient's chest. However, during setup, i.e. in an initial state or mode of the CPR device, the height adjustment mechanism H is arranged to allow the compression box CB to move in relation to the supporting structure L1, L2, F, so as to allow the compression box CB to enter a height where the contact pad is in contact with the patient's chest, upon clamping of the supporting structure L1, L2, F to the backboard.

Especially, the height adjustment mechanism H may comprise a suspension mechanism that controls horizontal movements of the compression box CB, e.g. in each side as shown, but allows the compression box CB to move by gravity in vertical direction (i.e. in and out of the paper plane on FIG. 1), to allow adjust a height of the compression box CB between an upper and a lower limit. Thus, during clamping of the CPR device onto the backboard, the contact pad will by gravity on the compression box CB be forced in contact with the patient's chest with a predetermined force. When clamped onto the backboard, the vertical position of the compression box CB is thus automatically set to a proper height to start a CPR sequence after the height adjustment mechanism has fixed the height of the compression box relative to the supporting structure L1, L2, F, e.g. by an electrically actuated locking mechanism controlled by the processor, e.g. in response to sensors positioned to sense that the clamps CL1, CL2 are properly locked to the backboard. Hereby, the processor can automatically initiate fixing of the height, and immediately afterwards control the plunger mechanism to initiate a CPR sequence. Hereby, the role of the operator is limited to perform the clamping of the CPR device onto the backboard. The CPR device can then automatically initiate a CPR sequence without any delaying factors, and without the operator having to perform any complicated adjustment of the height that influences the compression force of the CPR, and therefore also the effectiveness of the CPR treatment.

It is to be understood that there are several other methods to implement a height locking mechanism for fixing the height of the compression box CB. Such methods may either be automatically operated by the CPR device itself, or manually operated by the operator of the CPR device.

During storage, the CPR device is preferably in the initial non-activated state, where the compression box CB can freely move by gravity to its lower position, and thus occupy only a limited storage space. Further, the operator does not need to activate the device to perform the initial step of clamping it onto the backboard.

Alternative to the fully automated version, the operator may press a “start” button to activate the height fixation and the subsequent automatic initiation of a CPR sequence.

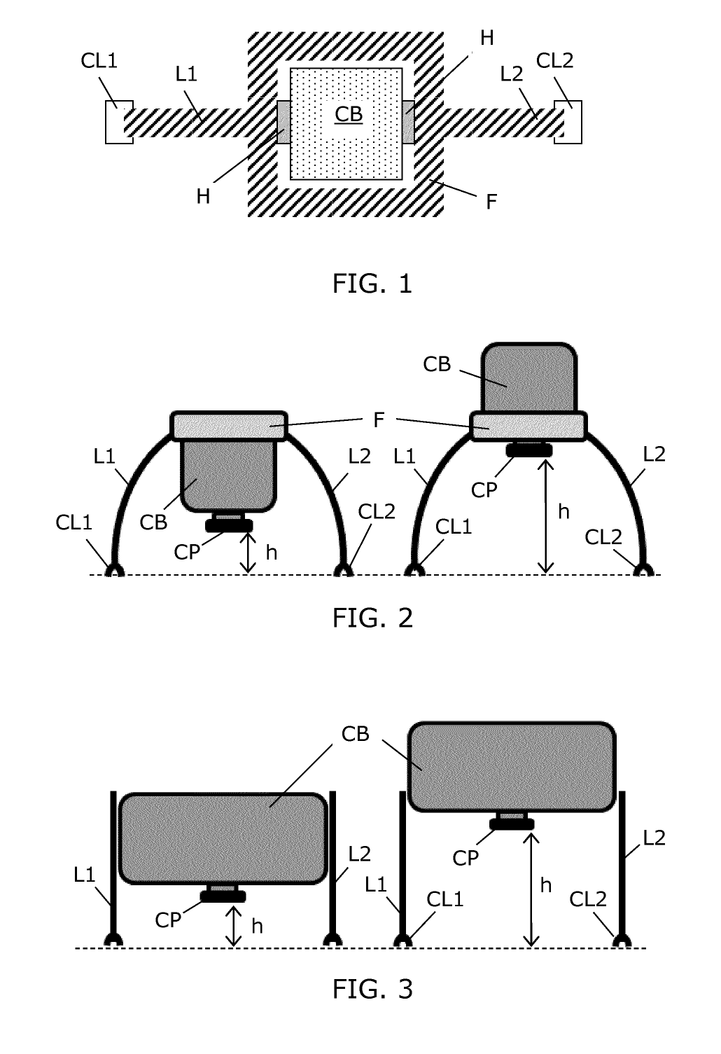

FIG. 2 shows a sketch of a CPR device embodiment with a supporting structure formed by a rigid connection of curved legs L1, L2 and a frame F in which a compression box CB is suspended. In principle the embodiment on FIG. 2 is structurally similar to the embodiment shown from above in FIG. 1. The legs are curved to provide space for the patient's thorax, and the rather narrow compression box CB provides a good view to the patient for the operator, during the setup procedure. Each leg L1, L2 has a clamp mechanism CL1, CL2 on its lower end to enable clamping onto a backboard. The height adjustment mechanism is not visible, but arranged within the frame F, see e.g. FIG. 1.

As seen, the contact pad CP of the plunger mechanism is visible, since it projects downwards from the enclosure or casing of the compression box CB. In the illustration to the left, the compression box is in its lower position, thus providing the contact pad CP to be in the smallest possible height h. In the illustration to the right, the compression box is shown in its upper position, i.e. where the contact pad is in the position providing the largest possible height h.

FIG. 3 shows a side view of another embodiment, where the height adjustment mechanism is arranged within the structure of the straight vertically extending legs L1, L2, thus allowing the compression box CB to slide to its lower position, shown to the left, and to its upper position, shown to the right. In this embodiment, the compression box CB fills the space between the legs L1, L2, however in such embodiment it may be possible to reduce the thickness of the compression box CB, thus still to provide a good visibility for the operator. The structures of the two legs L1, L2 are not structurally linked in this embodiment. Thus, it may be preferred to provide synchronization means to link a position of the two legs L1, L2 such that both legs have always equal position with respect to the compression box CB. This may be achieved by a mechanical link, and/or by an electric motor being controlled by electronic synchronization means.

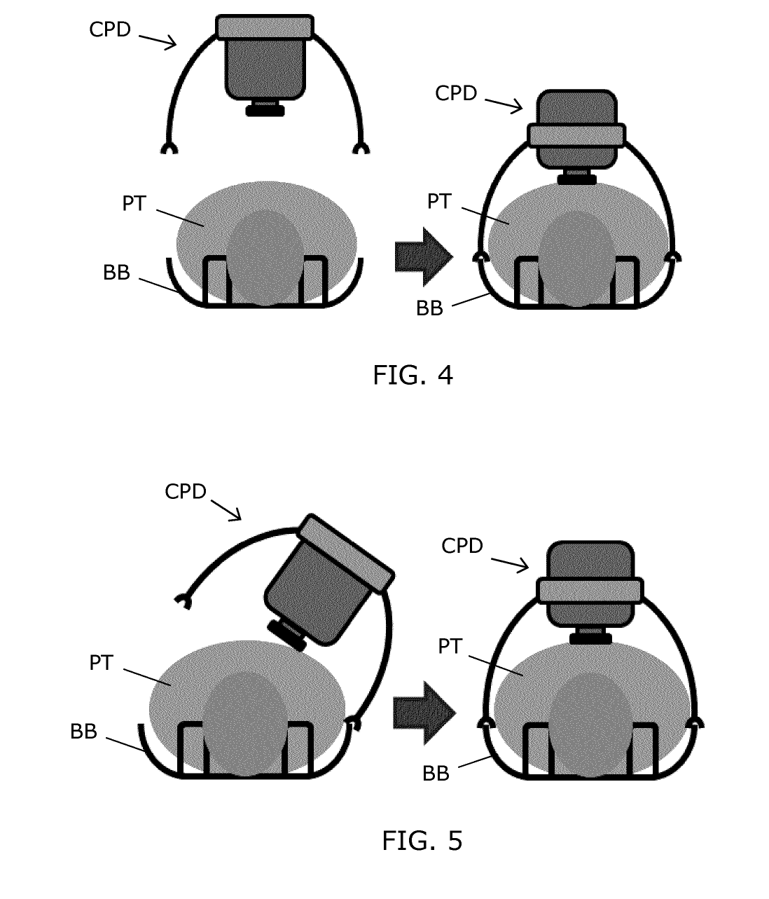

FIG. 4 shows, for the CPR device embodiment of FIG. 2, one possible way of clamping the CPR device CPD onto a backboard BB, where the thorax of the patient PT is positioned, to show the principle of the moving compression box during initial setup of the CPR device CPD. To the left, the an operator (not shown) has lifted the CPR device CPD above the patient PT, and as seen the compression box is here in its lower position. To the right, the operator (not shown) has now moved the CPR device CPD vertically downwards to make the clamps of the CPR device CPR engage with the corresponding clamp mechanisms on both side of the backboard BB at the same time. During this procedure, the contact pad is forced into contact with the patient's PT chest, due to gravity acting on the vertically free moving compression box, and thus the compression box rests on the patient's PT chest during the clamping procedure. When clamped onto the backboard BB, the compression box is thus in correct height position for start of CPR, and the operator can push a “start” button, or the CPR device may automatically start by fixing the height of the compression box, and subsequently start CPR treatment.

FIG. 5 shows a variant of the initial setup method in FIG. 4. Here, the operator (not shown) has lifted the CPR device CPD over the patient PT and clamped the CPR device CPD onto one side of the backboard BB. Then the operator (not shown) tilts the CPR device to bring the opposite side clamp into engagement with the backboard, and during this tilting operation, the freely moving compression box will force the contact pad into contact with the patient's PT chest, and thus finally, when clamped onto both sides of the backboard, the compression box will provide the correct pressure force of the contact pad onto the patient's PT chest.

It is to be understood that the plunger mechanism, contact pad, the processor and the CPR sequence referred to above can be selected such as known by the skilled person. The function related to the setup of the CPR device according to the invention, as explained above, may be program code forming part of the control program executed by the processor. The compression box may contain a battery to power the processor and the plunger mechanism, however the processor and plunger mechanism may alternatively be powered by an external power supply. Further, the CPR device may comprise an interface with indicators indicating the state or mode of the CPR device to the operator, and possibly one or more operator input means for the operator to control the function of the CPR device. Preferably, the compression box is suspended to provide a height between contact pad and backboard surface of such as 16 cm to 34 cm.

It is further to be understood that the force on the patient's chest referred to will also be known by the skilled person. Thus, the weight of the compression box, or its weight in combination with any spring mechanism acting on the compression box, can be selected so as to be within a suitable range for initial force on the patient's chest when starting CPR with an active CPR device.

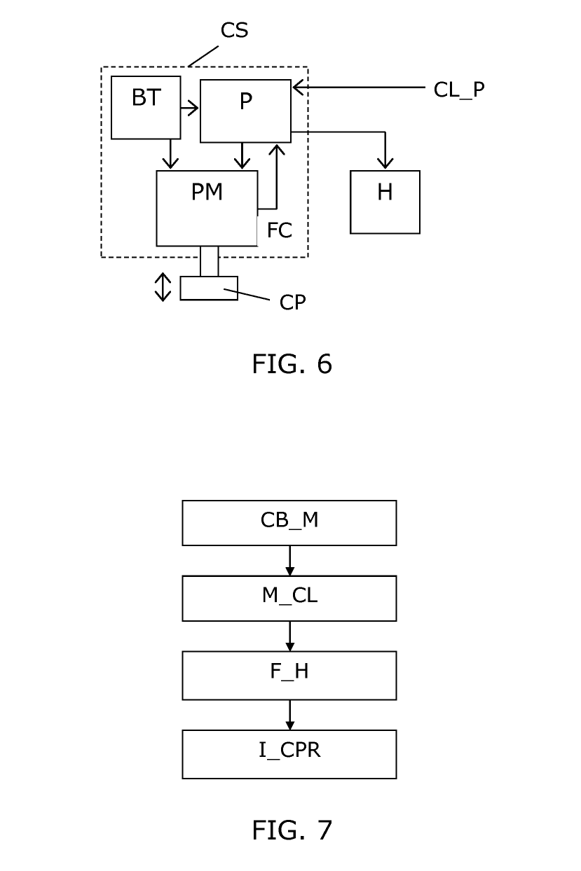

FIG. 6 shows a block diagram of elements contained inside an embodiment of a compression box for a CPR device. A casing CS forms an enclosure around a plunger mechanism PM controlled by a processor P. A rechargeable battery BT serves to deliver power to the processor and the plunger mechanism PM. The processor P can receive an input CL_P indicative of clamping of the backboard has been performed. In response, the processor can control the height adjustment mechanism H to fix the height of the compression box, e.g. by activating a locking mechanism. The processor P can then start controlling the plunger mechanism PM to run a CPR sequence. The plunger mechanism PM is connected to a contact pad CP which projects downward from the compression box to allow contact with the patient's chest. The CPR is performed by the plunger mechanism PM moving the contact pad CP up and down (see double arrow), so as to provide compressions of the patient's chest.

The processor P can receive an optional force censor input FC input from a force sensor arranged to sense the compression force on the patient's chest. When the processor detects an insufficiently low force during a CPR sequence, the processor can be programmed to stop the CPR sequence, to release the fixation of the compression box height in the height adjustment mechanism H. This allows the compression box to slide downwards, thus entering a new, lower height position. The processor P can then activate fixation in this new, lower height position, where the contact pad CP is again forced towards the patient's chest with the force provided by gravity acting on the compression box. The processor may also be capable of detecting a force censor input FC from a force sensor, and in case the sensed force is above a predetermined threshold, the processor P may be arranged to cause the plunger mechanism PM to retract, so as to reduce the applied contact force.

FIG. 7 illustrates steps of a method embodiment for initial setup of a CPR device for performing CPR on a patient. The device has a supporting structure with two legs shaped to accommodate space for the patient's thorax between them. A compression box has an enclosure containing a plunger mechanism with a contact pad projecting downwards from the enclosure, and arranged to provide a chest compression force to the patient's chest, and a processor arranged to control the plunger mechanism to perform CPR on the patient, and a height adjustment mechanism. First step is to enter an initial operating state CB_M of the CPR device, which is preferably an in-active state, or an “off” state, which the CPR device is already in during normal storage. In this state CB_M, the compression box is allowed to move freely in relation to the supporting structure between a lower and upper position, so as to allow the compression box to enter a height where the contact pad is in contact with the patient's chest. Next, the operator manually clamps M_CL the supporting structure onto the backboard. During this step, the compression box will be in its lower position, when the operator lifts the CPR device, and during the step of manually clamping the supporting structure of the CPR device onto the backboard, the contact pad will be forced into contact with the patient's chest, and thus apply a force on the patient's chest, when the CPR device is clamped onto the backboard. Then, the height of the compression box is fixed F_H by means of the height adjustment mechanism after the supporting structure has been clamped onto the associated backboard. This is possible immediately after the clamping procedure, since the compression box will automatically be at the correct height position for starting of a CPR sequence. Thus, after fixing the height of the compression box relative to the supporting structure, the compression box is in fixed connection with the backboard, and then finally, CPR can be initiated I_CPR.

As already explained, the various steps expect the manual clamping M_CL onto the backboard, can be performed automatically by the CPR device, or it can involve the operator starting the CPR device, and it can even involve the operator manually fixing the height F_H after the clamping procedure M_CL.

The invention allows a CPR device with a fast device setup and initial setup workflow. Interruptions are important to minimize. With the use of the moving compression box principle, device setup can be executed faster, which is a key aspect in minimizing no CPR compression time on a patient. The setup can be faster because the application of the CPR device on the backboard and the height adjustment of the compression box including the contact pad can be performed as one single fluent step. This allows saving of a critical step in the setup procedure over the prior art concepts. The preferred setup solution only consists of the application of the backboard under the patient, and applying the CPR device onto the correct spot on the sternum of the patient without the operator having to take the hands of the CPR device at any time, requiring a total of two steps.

It is difficult to place the contact pad with the correct force on the thorax so that the contact pad is not leaning on the chest. Another challenge is adapting to molding of the patient's chest during ongoing CPR compressions. Molding means that due to the resuscitation the distance between the back and the sternum of the patient becomes less because the sternum does not return to its starting position. With the CPR device according to the invention, setup of the CPR device can automatically adjust for too much and to less force on the contact pad. When there is too much force on the contact pad the pad, the contact pad can be pulled back a bit by the compression box so that the pad is keeping contact with the chest with less force. When there is too less force on the chest, e.g. due to molding, the CPR device can release the fixing of the height, and let the moving box move down by gravity. The CPR device can the again fix or lock the height of the compression box and continue CPR. If the moving box was lowered too much so that the pad is with too much force on the chest, the compression pad can be pulled back a bit so that the pad is with less force on the chest and then continue CPR.

It is important to have a good view on the chest surface for an operator. With the CPR device according to the invention, the compression box is always as close as possible to the patient's chest, due to gravity during setup, and the view on the chest surface is thus optimal. It is also an advantage when the device is used in a cathlab. In a cathlab a C-arm X-ray device moves around the patient. Thus, more free space above the patient facilitates free movement of the X-ray device around the patient.

Shift of compression point position is unacceptable. A key requirement is to have a stable CPR device. Position of the contact pad during operation is very important and could be disturbed by e.g. vibration/mechanical shock during transport in ambulances or helicopters. Furthermore, rocking of the CPR device due to the complex chest deformation is reduced. With the use of the moving compression box principle, CPR device according to the invention has a low center of mass compared to moving plunger CPR devices. Thus, the low center of mass results in a more stable device which is less vulnerable for disturbances which lead to incorrect compressions and safety issues for the patient and caregiver in case of rapid speed changes of the vehicle in which CPR is being performed. Further, because the plunger mechanism can be made with a short arm (because the compression box is near the patient, the plunger can be short), disturbances at the top of the plunger will not translate to large movements at the patient.

With the use of a the moving compression box, the total device height is as low as possible for a specific patient. This is important for patients with chest sizes and thicknesses smaller than the maximum device limit. In contrast, a moving plunger device has total device height being fixed, and thus always maximum. Keeping the device low can be an advantage for accessing the patient, for fitting the device in an ambulance/helicopter or for possible (CT-) scans that require a certain proximity or angle with respect to the patient. Still further, the CPR device can be packaged in a compact way, and thus fits in ambulances etc. with small storage spaces.

To sum up, the invention provides a CPR device CPD for performing CPR on a patient PT. A supporting structure L1, L2, F with two legs L1, L2 shaped to accommodate space for the patient's PT thorax between them. The legs L1, L2 have clamp mechanisms CL1, CL2 to allow clamping onto a backboard BB. A compression box CB with a plunger mechanism PM with a contact pad CP projecting downwards from the enclosure CS, and a processor P for controlling the plunger mechanism PM to perform CPR on the patient PT in an automatic manner. A height adjustment mechanism H is used to fix a height h of the compression box CB relative to the supporting structure L1, L2, F. The height adjustment mechanism H can allow the compression box CB to move in relation to the supporting structure L1, L2, F in a first operating state, by help of gravity. Hereby, the compression box CB can enter a height H where the contact pad is in contact with the patient's PT chest, preferably within a predetermined contact force range, upon clamping of the supporting structure L1, L2, F onto the backboard BB. Hereby, the height and contact force parameters are inherently set automatically by the device, when the operator has clamped the CPR device CPD onto the backboard BB. This setup task is easy for the operator, time without CPR can be saved, and CPR can be initiated with a correct contact force.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A Cardiac Pulmonary Resuscitation device arranged to perform Cardiac Pulmonary Resuscitation on a patient, the device comprising:
a supporting structure comprising first and second legs shaped to accommodate space for the patient's thorax between the first and second legs, wherein the first and second legs each has a clamp mechanism arranged for engagement with corresponding clamp mechanisms on each side of an associated backboard, so as to allow an operator to clamp the supporting structure onto the associated backboard,
a compression box comprising an enclosure containing:
a plunger mechanism with a contact pad projecting downwards from the enclosure, and arranged to provide a chest compression force to the patient's chest, and
a processor arranged to control the plunger mechanism to perform Cardiac Pulmonary Resuscitation on the patient, and
the device further comprising:
a height adjustment mechanism arranged to fix a height of the compression box relative to the supporting structure, wherein
in a first operating state of the device, upon clamping of the supporting structure onto the associated backboard, the height adjustment mechanism is arranged to allow the compression box to slide by gravity in relation to the supporting structure, so as to press the contact pad against the patient's chest with a force determined by the mass of the compression box, and
a spring mechanism arranged to force the compression box downwards, so as to press the contact pad against the patient's chest with a predetermined force, in the first operating state.

2. Device according to claim 1, wherein the height adjustment mechanism is arranged to fix a height of the compression box relative to the supporting structure, in a second operating state.

3. Device according to claim 2, wherein the processor is arranged to enter the second operating state in response to one of: an input from the operator, and an input from a sensor informing the processor that the supporting structure has been clamped onto the associated backboard.

4. Device according to claim 1, wherein the processor is arranged to automatically initiate a Cardiac Pulmonary Resuscitation sequence after the height adjustment mechanism has fixed the height of the compression box relative to the supporting structure.

5. Device according to claim 1, wherein the height adjustment mechanism is arranged to fix a height of the compression box relative to the supporting structure in one of a plurality of possible height positions.

6. Device according to claim 1, wherein the height adjustment mechanism is arranged to fix a height of the compression box relative to the supporting structure in a position corresponding to an actual height position of the compression box, upon activation of the device.

7. Device according to claim 1, wherein the height adjustment mechanism comprises a locking pin arrangement arranged to fix a height of the compression box relative to the supporting structure, in one of a limited number of height positions.

8. Device according to claim 1, wherein the height adjustment mechanism is arranged to fix a height of the compression box relative to the supporting structure, in response to an output from the processor.

9. Device according to claim 1, wherein the height adjustment mechanism is arranged to release the compression box from a fixed height position relative to the supporting structure, in response to an output from the processor.

10. Device according to claim 9, wherein the processor generates said output in response to a detected force applied to the patient's chest being below a predetermined threshold value.

11. Device according to claim 1, wherein the supporting structure comprises a frame structure rigidly connected to the first and second legs, so as to form a rigid supporting structure, and wherein the compression box is arranged to slide inside the frame.

12. Device according to claim 1, wherein the height adjustment mechanism is positioned at least partly inside structures forming the first and second legs.

13. A method for initial setup of a device for performing Cardiac Pulmonary Resuscitation on a patient, the device comprising a supporting structure comprising first and second legs shaped to accommodate space for the patient's thorax between the first and second legs, a compression box comprising an enclosure containing: a plunger mechanism with a contact pad projecting downwards from the enclosure, and arranged to provide a chest compression force to the patient's chest, and a processor arranged to control the plunger mechanism to perform Cardiac Pulmonary Resuscitation on the patient (PT), a height adjustment mechanism, and a spring mechanism
entering a first operating state of the device, wherein the height adjustment mechanism is arranged to allow the compression box to slide by gravity in relation to the supporting structure with a force determined by the mass of the compression box, and the spring mechanism is arranged to force the compression box downwards so as to press the contact pad against the patient's chest with a predetermined force, in the first operating state,
manually clamping the supporting structure onto an associated backboard, and
fixing a height of the compression box by means of the height adjustment mechanism and the spring mechanism after the supporting structure has been clamped onto the associated backboard.
